(19) United States
(12) Patent Application Publication
(10) Pub. No.: US 2003/0126397 A1
(43) Pub. Date: Jul. 3, 2003

(54) Configurable addressing apparatus

(76) Inventors: Stephan Junge, Munchen (DE); Steffen Sonnekalb, Munchen (DE); Andreas Wenzel, Munchen (DE)

Correspondence Address: JENKINS & WILSON, PA, 3100 TOWER BLVD, SUITE 1400, DURHAM, NC, 27707, US

(21) Appl. No.: 10/185,848

(22) Filed: Jun. 27, 2002

(30) Foreign Application Priority Data
Jun. 28, 2001 (DE) 10131124.9

(51) Int. Cl. G06F 12/00

(52) U.S. Cl. 711/200; 711/215; 711/202

(57) ABSTRACT

Apparatus for addressing a data memory (21), with the apparatus (1) having:

an instruction register (2) for buffer-storing a program instruction, which comprises an instruction opcode, a memory configuration selection pointer (2b) for selection of a memory configuration register field, configuration bits (2c) and offset address bits (2d), a memory configuration register (11) which comprises a number of memory configuration register fields (11-i) which store different mapping instructions for generation of a data memory address in the data memory (21), a number of data memory segment registers (14) which each store the most significant address bits of a start address for a data memory segment, at least one additional data memory segment register (16) which stores the most significant address bits of a start address for a data memory segment, a switching mechanism (9) which reads the mapping instruction from the selected memory configuration register field (11-i) as a function of the memory configuration selection pointer read from the instruction register (2), and, depending on the mapping instruction that is read, and as a function of the configuration bits (2c) read from the instruction register (2), composes the most significant address bits from a data memory segment register (14) or an additional data memory segment register (16) and from the configuration bits (2c) read from the instruction register (2), and writes the result to an address register (19) which buffer-stores a data memory address for addressing the data memory (21), with the least significant address bits of the address register (19) being taken from the offset address bits (2d) which are buffer-stored in the instruction register (2).

### DESCRIPTION

The invention relates to a configurable addressing apparatus for addressing a data memory.

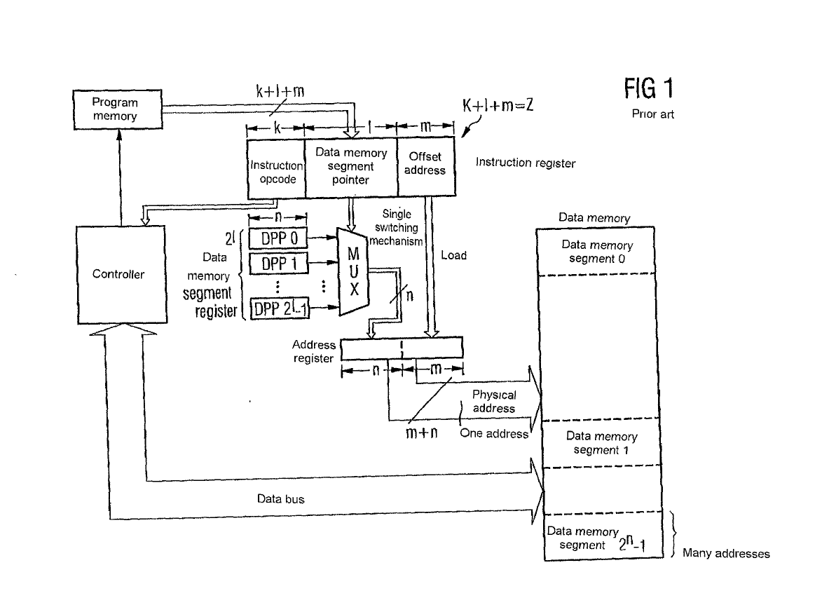

FIG. 1 shows an addressing apparatus for addressing a data memory according to the prior art.

A program memory is used to store a large number of instructions, which are loaded via data lines into an instruction register during the running of the program. The program instruction which is loaded into the instruction register comprises an instruction opcode, a data memory segment pointer and an offset address. The instruction opcode is loaded into a central controller, for example a microprocessor, in order to carry out the instruction. The data memory segment pointer controls a multiplexer, whose input side is connected to a number of data memory segment registers. The multiplexer connects one data memory segment register to its output, depending on the data memory segment pointer. In this way, the data content of the data memory segment register which is passed on is written as the most significant address bits to an address register, with the data content of the data memory segment register which is passed on indicating the addressed data memory segment in the data memory. The offset address bits which are contained in the instruction register are copied directly as the least significant address bits into the address register. The physical address for addressing a data memory element within the data memory is buffer-stored in the address register. In this case, the physical address is composed of the start address of the addressed data memory segment and the offset address.

If the data memory segment pointer comprises L data bits, 2^{L} data memory segment registers may be selected, so that a maximum of 2^{L} data memory segments may also be addressed within the data memory, provided that the data content of the data memory segment registers is not modified during the running of the program.

The following table shows a simple example with four data memory segment registers for determining the most significant address bits of a physical address with a length of 24 bits.

TABLE 1
Switching mechanism for determining the most
significant address bits using 4 data memory segment
registers (based on the present prior art)

| | Output | |
|---|---|---|
| | signals: | |
| | Most | |
| Input signals: | significant | Explanation |
| Data memory segment pointer | address bits | Memory size |

| Bit 15 in the | Bit 14 in the | Bits 23-14 in | of the data |
|---|---|---|---|
| instruction | instruction | the address | memory |
| register | register | register | segment |
| 0 | 0 | DPP0.9-0 | 16 kbytes |
| 0 | 1 | DPP1.9-0 | 16 kbytes |
| 1 | 0 | DPP2.9-0 | 16 kbytes |
| 1 | 1 | DPP3.9-0 | 16 kbytes |

DPP0.9-0: Bits 9-0 in the data memory segment register DPP0
DPP1.9-0: Bits 9-0 in the data memory segment register DPP1
DPP2.9-0: Bits 9-0 in the data memory segment register DPP2
DPP3.9-0: Bits 9-0 in the data memory segment register DPP3
16 kbytes = 16 * 1024 bytes = 2¹³ bytes

In the example mentioned above, the data memory segment pointer comprises two bits, namely the bit positions 14, 15 within the instruction register, and the offset address comprises 14 bits, namely the bit positions 0-13 within the instruction register. The data memory segment pointer allows four different data memory segment registers DPP0-DPP3 to be addressed. Each of these data memory segment registers has a bit length of 10 bits. A physical address with a bit length of 24 bits is formed in the address register, with the most significant 10 bits in accordance with Table 1 being written from one data memory segment register, and the least significant 14 bits being copied from the offset address of the instruction register. The segment size of the addressed data memory segment is obtained by means of the calculation rule (2^{z-1}), where z is the bit length of the offset address, so that a segment size of 2¹⁴⁻¹ bytes=16 kbytes is calculated in this case for z=14.

The addressing apparatus as illustrated in FIG. 1 and according to the prior art has the disadvantage that the number of addressable data memory segment registers as well as the memory size of the individual data memory segments are fixed. The addressing process is thus highly inflexible. In the example mentioned in the table above, four data memory segment registers may be addressed, so that it is possible to access four data memory segments in the data memory, each having a fixed memory size of 16 kbytes.

Furthermore, the addressing apparatus according to the prior art and as is illustrated in FIG. 1 has the disadvantage that the process of programming a program which is to be executed is highly complex. If, for example, the program has to access more than four different data memory segments while running a program with four data memory segment registers in the above example, then this can be done only by means of additional complexity. For this purpose, the data content of one data memory segment register must be modified by carrying out a further program instruction. The program code for these additional program instructions must likewise be stored in the program memory. This increases the memory space required within the program memory, and likewise increases the program running time.

It has thus been proposed that the bit length of the data memory segment pointer within the program instruction be increased in order in this way to make it possible to select between more [sic] data memory segment registers, so that it is possible to access additional data memory segments in the data memory.

Table 2 shows the process for determining the most significant address bits of a physical address with 24 bits using a data memory segment pointer with three bits, namely the bit positions 13-15 within the instruction register, and an offset address with 13 bits, namely the bit positions 0-12 within the instruction register. The number of addressable data memory segment registers is twice as great as that in the example illustrated in Table 1, since the data memory segment pointer has an additional bit. The data memory segment size is half that for the example illustrated in Table 1, since the bit length of the offset address is reduced by 1. The sum of the bit length of the data memory segment pointer and of the bit length of the offset address does not change from that in the example illustrated in Table 1.

TABLE 2
Switching mechanism for determining the most
significant address bits using 8 data memory segment
registers (likewise according to the present prior art)

| | | | Output | |
|---|---|---|---|---|
| | | | signals: | |
| | | | Most | |
| Input signals: | | | significant | Explana- |
| Data memory segment pointer | | | address | tion |
| Bit 15 in | Bit 14 in | Bit 13 in | bits | Memory |
| the | the | the | Bits 23-13 | size of |
| instruc- | instruc- | instruc- | in the | the data |
| tion | tion | tion | address | memory |
| register | register | register | register | segment |
| 0 | 0 | 0 | DPP0.10-0 | 8 kbytes |
| 0 | 0 | 1 | DPP1.10-0 | 8 kbytes |
| 0 | 1 | 0 | DPP2.10-0 | 8 kbytes |
| 0 | 1 | 1 | DPP3.10-0 | 8 kbytes |
| 1 | 0 | 0 | DPP4.10-0 | 8 kbytes |
| 1 | 0 | 1 | DPP5.10-0 | 8 kbytes |
| 1 | 1 | 0 | DPP6.10-0 | 8 kbytes |
| 1 | 1 | 1 | DPP7.10-0 | 8 kbytes |

DPP0.10-0: Bits 10-0 in the data memory segment register DPP0
DPP1.10-0: Bits 10-0 in the data memory segment register DPP1
DPP2.10-0: Bits 10-0 in the data memory segment register DPP2
DPP3.10-0: Bits 10-0 in the data memory segment register DPP3
DPP4.10-0: Bits 10-0 in the data memory segment register DPP4
DPP5.10-0: Bits 10-0 in the data memory segment register DPP5
DPP6.10-0: Bits 10-0 in the data memory segment register DPP6
DPP7.10-0: Bits 10-0 in the data memory segment register DPP7
8 kbytes = 8 * 1024 bytes = 2¹² bytes

The example shown in Table 2 allows eight different data memory segment registers DPP0-DPP7 to be addressed by the data memory segment pointer. Each data memory segment register has a bit length of 11 bits. A physical address with a bit length of 24 bits is formed in the address register, with the most significant 11 bits being written, in accordance with Table 2, from one data memory segment register, and the least significant 13 bits being copied from the offset address of the instruction register. The segment size of the addressed data memory segment is obtained by means of the calculation rule (2^{z-1}), where z is the bit length of the offset address, so that in this case a segment size of 2¹³⁻¹ bytes=8 kbytes is calculated for z=13.

However, an addressing apparatus such as this has the disadvantage that it does not provide program code compatibility with previous programs. Existing programs which have been written, by way of example, for an addressing apparatus according to Table 1 are written such that bit 13 within the instruction register is copied unchanged to the address register. If the bit length of the offset address is reduced in order to increase the bit length of the data memory segment pointer, as has been done in Table 2, existing programs can no longer run on an addressing apparatus such as this and require adaptation to the modified addressing apparatus.

The object of the present invention is thus to provide an addressing apparatus for addressing a data memory, in which the number of available data memory segment registers is increased, and which nevertheless ensures that existing programs will still be able to run.

According to the invention, this object is achieved by an addressing apparatus having the features specified in Patent claim 1.

The invention provides an apparatus for addressing a data memory, with the apparatus having:

an instruction register for buffer-storing a program instruction, which comprises an instruction opcode, a memory configuration selection pointer for selection of a memory configuration register field, configuration bits and offset address bits,

a memory configuration register which comprises a number of memory configuration register fields which store different mapping instructions for generation of a data memory address in the data memory,

a number of data memory segment registers which each store the most significant address bits of a start address for a data memory segment, at least one additional data memory segment register which stores the most significant address bits of a start address for a data memory segment,

a switching mechanism which reads the mapping instruction from the selected memory configuration register field as a function of the memory configuration selection pointer read from the instruction register, and, depending on the mapping instruction that is read, and, as a function of the configuration bits read from the instruction register, composes the most significant address bits from a data memory segment register or an additional data memory segment register and from the configuration bits read from the instruction register, and writes the result to an address register which buffer-stores a data memory address for addressing the data memory,

with the least significant address bits of the address register being taken from the offset address bits which are buffer-stored in the instruction register.

In a further preferred embodiment of the addressing apparatus according to the invention, the memory configuration register field indicates a mapping rule which, for each individual bit of the configuration bits which are stored in the instruction register, defines whether this bit should be interpreted as an offset address bit or as a selection bit for selection of a data memory segment register/additional data memory segment register, and which also defines which data memory segment registers/additional data memory segment registers are still available for selection.

In a further preferred embodiment of the addressing apparatus according to the invention, each bit of the configuration bits which are stored in the instruction register is interpreted either as a selection bit for selection of a data memory segment register/additional data memory segment register or as an additional offset address bit.

In a further preferred embodiment of the addressing apparatus according to the invention, the additional offset address bits are written by the switching mechanism to the most significant address bits in the address register.

In a further preferred embodiment of the addressing apparatus according to the invention, the number of bits which are read from the addressed data memory segment register/additional data memory segment register and which the switching mechanism writes to the most significant address bits in the address register is obtained by means of the calculation rule (h-o), where h is the number of most significant address bits in the address register and o is the number of additional offset address bits.

A further preferred embodiment of the addressing apparatus according to the invention has a switching mechanism which composes the most significant address bits from the additional offset address bits and from the bits which are read from the selected data memory segment register/additional data memory segment register.

Offset address bits, configuration bits, selection bits and opcode bits are preferably buffer-stored in the instruction register.

The number of most significant address bits is preferably constant. The number of least significant address bits is preferably constant. The memory size of the addressed data memory segment is obtained by means of the calculation rule (2^{o+z-1}) where o is the number of offset address bits and z is the number of additional offset address bits.

One preferred embodiment of the addressing apparatus according to the invention will be described in the following text with reference to the attached figures in order to explain features which are essential to the invention.

In the figures:

FIG. 1 shows an addressing apparatus for a data memory according to the prior art;

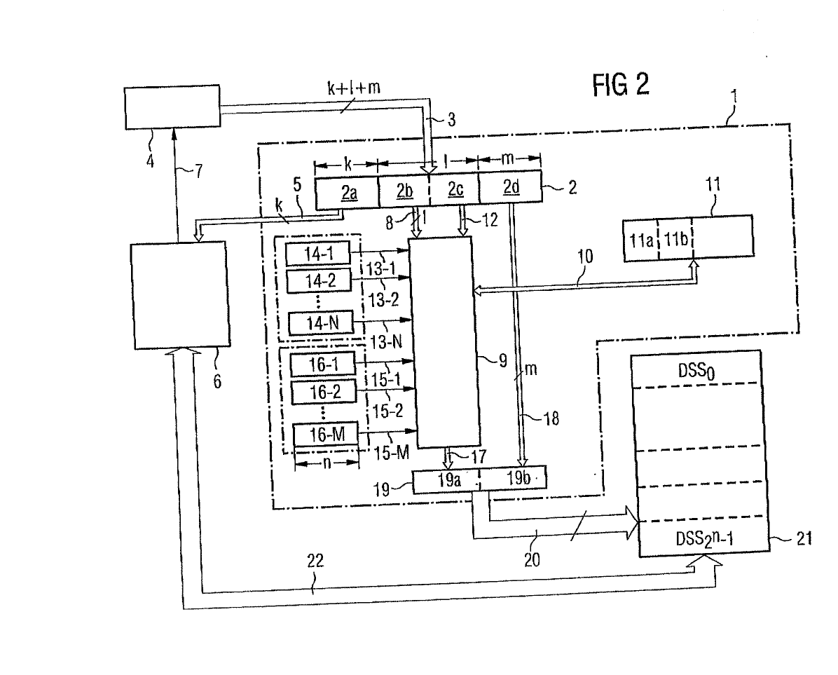

FIG. 2 shows a block diagram with an addressing apparatus according to the invention for a data memory.

FIG. 2 shows an addressing apparatus 1 according to the invention with an instruction register 2 which is connected to a program memory 4 via data lines 3. The program instructions to be carried out are written from the program memory 4 to the instruction register 2 via the data lines 3. The program instruction which is written to the instruction register 2 comprises an instruction opcode with k data bits, which are written to a first area 2a of the instruction register. The instruction opcode data bits are written via lines 5 to a central controller 6, for example a microprocessor, which carries out the coded instruction. The central controller controls the program memory 4 and hence the running of the program, via control lines 7. In addition to the instruction opcode bits, the program instruction contains a memory configuration selection pointer, which comprises a number of selection bits which are written to a second area 2b of the instruction register. The program instruction contains configuration bits which are written in a third area 2c of the instruction register 2. Furthermore, the instruction which is read from the program memory 4 contains offset address bits, which are written to a fourth area 2d of the instruction register 2. The area 2d is connected via data lines 18 to an address register 19 for copying the offset address bits.

The memory configuration selection pointer which is written in the area 2b of the instruction register 2 and comprises L selection bits is read in via lines 8 by means of a switching mechanism 9, which is connected via lines 10 to a memory configuration register 11. The memory configuration register 11 comprises a number of memory configuration register fields 11a, 11b . . . . Each memory configuration register field within the memory configuration register 11 indicates a desired mapping rule for generation of a data memory address in the data memory. Each individual bit of the configuration bits 2c is interpreted by the switching mechanism 9 either as an additional offset address bit or as a selection bit for selection of a data memory segment register/additional data memory segment register depending on the mapping rule or the mapping instruction selected by the L selection bits, with the selected mapping rule defining which data memory segment registers/additional data memory segment registers are still available for selection.

The switching mechanism 9 is furthermore connected via data lines 12 to the third area 2c of the instruction register 2, for loading of the configuration bits contained in it. The switching mechanism 9 is connected via data lines 13 to N data memory segment registers 14. Furthermore, the switching mechanism 9 is connected via lines 15 to M additional data memory segment registers 16. The memory configuration selection pointer which is buffer-stored in the memory area 2b of the instruction register 2 for the loaded instruction is read in by the switching mechanism 9, which reads the data content of that memory configuration register field 11-i within the memory configuration register 11 that is addressed by the memory configuration selection pointer. The memory configuration register field 11-i indicates which data memory segment registers/additional data memory segment registers for the generation of the data memory address are still available for selection. Furthermore, the mapping rule which is stored in the memory configuration register field 11-i indicates, for each individual bit of the configuration bits 2c, whether this bit should be interpreted as a selection bit for selection of a data memory segment register/additional data memory segment register, or should be interpreted as an additional offset address bit. The number of bits which are read from the addressed data memory segment register/additional data memory segment register and which the switching mechanism writes together with the additional offset address bits to the most significant address bits of the address register 19 is obtained by means of the calculation rule (h-o), where h is the number of most significant address bits of the address register, and o is the number of additional offset address bits.

The physical address for addressing a data memory element within the data memory is buffer-stored in the address register 19. The address register 19 is subdivided into most significant address bits 19a and least significant address bits 19b. The address register 19 is connected via address lines 20 to a data memory 21, which is connected via a data bus 22 to the controller 6.

The switching mechanism 9 is connected via data lines 17 to the most significant address bits 19a of the address register 19. The least significant address bits 19b of the address register 19 are connected to the area 2d of the instruction register.

The switching mechanism 9 composes the most significant address bits 19a of the physical address that is buffer-stored in the address register 19 depending on the mapping rule which is read from the memory configuration register field 11-i. The most significant address bits are composed by the switching mechanism 9 from the additional offset address bits, which are read from the configuration bits 2c as a function of the mapping rule, and from the bits which are read from the selected data memory segment register 14-i/additional data memory segment register 16-i, and are written via lines 17 to the area 19a of the address register 19.

The bit length of the fields 19a and 19b of the address register 19 is always constant, so that the bit length of the address register 19 also always remains constant.

The memory size of the addressed data memory segment is obtained by means of the calculation rule (2^{o+z-1}), where o is the number of offset address bits, and z is the number of additional offset address bits.

Tables 3, 4, 5 and 6 describe one preferred embodiment of the switching mechanism 9 within the addressing apparatus 1 according to the invention.

In the illustrated example, the memory configuration selection pointer comprises two bits, namely the bit positions 14, 15 within the instruction register 2, the configuration bits comprise a single bit, namely bit 13 within the instruction register 2, and the offset address comprises 13 bits, namely the bit positions 0-12 within the instruction register 2.

The memory configuration register 11 in the illustrated example contains four memory configuration register fields, which are referred to as DPP0SEL, DPP1SEL, DPP2SEL, DPP3SEL.

The switching mechanism 9 reads via the lines 8 the memory configuration selection pointer which, in the illustrated example, comprises the bits 14-15 within the instruction register 2. The switching mechanism 9 reads the mapping rule from the addressed memory configuration register field of the memory configuration register 11 depending on the memory configuration selection pointer at that time, and forms the physical address, which is written to the address register 19, as a function of the memory configuration indicated there.

In the illustrated example, the memory configuration register field DPP0SEL is addressed when bit 15 of the instruction register=0 and bit 14 of the instruction register=0, and, in this case, the mapping rule for determining the most significant bits of the physical address is carried out in accordance with Table 3.

The memory configuration register field DPP1SEL is addressed when bit 15 of the instruction register=0 and bit 14 of the instruction register=1 and, in this case, the mapping rule for determining the most significant bits of the physical address is carried out in accordance with Table 4.

The memory configuration register field DPP2SEL is addressed when bit 15 of the instruction register=1 and bit 14 of the instruction register=0 and, in this case, the mapping rule for determining the most significant bits of the physical address is carried out in accordance with Table 5.

The memory configuration register field DPP3SEL is addressed when bit 15 of the instruction register=1 and bit 14 of the instruction register=1 and, in this case, the mapping rule for determining the most significant bits of the physical address is carried out in accordance with Table 6.

The content of the memory configuration register field indicates, for each individual configuration bit in the instruction register, whether this bit should be interpreted as a selection bit for selection of a data memory segment register/additional data memory segment register or as an additional offset address bit and, in addition, defines which data memory segment registers/additional data memory segment registers are still available for selection.

In the illustrated example, the memory configuration register field DPPCON0 as shown in Table 3 indicates whether bit 13 of the instruction register in which the configuration bit is stored should be interpreted as a selection bit or as an additional offset address bit.

If this bit is interpreted as an additional offset address bit, then the data memory segment register DPP0 is addressed (see row 3 in Table 3), with 10 bits in this case being read from the data memory segment register DPP0 and being written together with the additional offset address bit to the 11 most significant bits of the address register. If, on the other hand, bit 13 of the instruction register is interpreted as a selection bit, then this bit is used to select between the data memory segment register DPP0 and the additional data memory segment register EDPP0 and, as shown in rows 4 and 5 of Table 3, 11 bits of the addressed data memory segment register/additional data memory segment register are read, and are written to the most significant bits of the address register.

In the illustrated example, the memory configuration register field DPPCON1 as shown in Table 4 indicates whether bit 13 of the instruction register in which the configuration bit is stored should be interpreted as a selection bit or as an additional offset address bit. If this bit is interpreted as an additional offset address bit, then the data memory segment register DPP1 is addressed (see row 3 in Table 4), with 10 bits in this case being read from the data memory segment register DPP1 and being written together with the additional offset address bit to the 11 most significant bits of the address register. If, on the other hand, bit 13 of the instruction register is interpreted as a selection bit, then this bit is used to select between the data memory segment register DPP1 and the additional data memory segment register EDPP1, and, in accordance with rows 4 and 5 in Table 4, 11 bits of the addressed data memory segment register/additional data memory segment register are read, and are written to the most significant bits of the address register.

In the illustrated example, the memory configuration register field DPPCON2 in accordance with Table 5 indicates whether bit 13 of the instruction register in which the configuration bit is stored should be interpreted as a selection bit or as an additional offset address bit. If this bit is interpreted as an additional offset address bit, then the data memory segment register DPP1 is addressed (see row 3 of Table 5), with 10 bits in this case being read from the data memory segment register DPP2 and being written together with the additional offset address bit to the 11 most significant bits of the address register. If, on the other hand, bit 13 of the instruction register is interpreted as a selection bit, then this bit is used to select between the data memory segment register DPP2 and the additional data memory segment register EDPP2 and, in accordance with rows 4 and 5 of Table 5, 11 bits of the addressed data memory segment register/additional data memory segment register are read, and are written to the most significant bits of the address register.

In the illustrated example, the memory configuration register field DPPCON3 in accordance with Table 6 indicates whether bit 13 of the instruction register in which the configuration bit is stored should be interpreted as a selection bit or as an additional offset address bit. If this bit is interpreted as an additional offset address bit, then the data memory segment register DPP1 is addressed (see row 3 of Table 6), with 10 bits in this case being read from the data memory segment register DPP3 and being written together with the additional offset address bit to the 11 most significant bits of the address register. If, on the other hand, bit 13 of the instruction register is interpreted as a selection bit, then this bit is used to select between the data memory segment register DPP3 and the additional data memory segment register EDPP3 and, in accordance with rows 4 and 5 of Table 6, 11 bits of the addressed data memory segment register/additional data memory segment register are read, and are written to the most significant bits of the address register.

TABLE 3
Switching mechanism for determining the most
significant address bits for selection of the mapping
rule which is stored in DPP0SEL.
(Addressing apparatus according to the invention)

| | | | | Output signals: | | Expla- |
|---|---|---|---|---|---|---|
| | Input signals | | | Most significant | | nation |
| Input signals: | Bits 15-13 of | | | address bits | | Memory |
| Memory | the instruc- | | | Bits 23-14 | | size of |
| configura- | tion register | | | of the | Bit 13 of | the data |
| tion register | Bit | Bit | Bit | address | the address | memory |
| field DPP0SEL | 15 | 14 | 13 | register | register | segment |
| Bit 13 of the | 0 | 0 | * | DPP0.9-0 | Bit 13 of | 16 kbytes |
| instruction | | | | | the | |
| register is | | | | | instruction | |
| an additional | | | | | register ( = | |
| offset bit | | | | | additional | |
| | | | | | offset bit) | |
| Bit 13 of the | 0 | 0 | 0 | DPP0.9-0 | DPP0.10 | 8 kbytes |
| instruction | | | | | | |
| register is a | | | | | | |
| selection bit | | | | | | |
| Bit 13 of the | 0 | 0 | 1 | EDPP0.9-0 | EDPP0.10 | 8 kbytes |
| instruction | | | | | | |
| register is a | | | | | | |
| selection bit | | | | | | |

where
DPP0.9-0: Bits 9-0 in the data memory segment register DPP0
DPP0.10: Bit 10 in the data memory segment register DPP0
EDPP0.9-0: Bits 9-0 in the additional data memory segment register EDPP0
EDPP0.10: Bit 10 in the additional data memory segment register EDPP0

TABLE 4
Switching mechanism for determining the most
significant address bits for selection of the mapping
rule which is stored in DPP1SEL.
(Addressing apparatus according to the invention)

| | | | | Output signals: | | Expla- |
|---|---|---|---|---|---|---|
| | Input signals | | | Most significant | | nation |
| Input signals: | Bits 15-13 of | | | address bits | | Memory |
| Memory | the instruc- | | | Bits 23-14 | | size of |
| configura- | tion register | | | of the | Bit 13 of | the data |
| tion register | Bit | Bit | Bit | address | the address | memory |
| field DPP1SEL | 15 | 14 | 13 | register | register | segment |
| Bit 13 of the | 0 | 1 | * | DPP1.9-0 | Bit 13 of | 16 kbytes |
| instruction | | | | | the | |
| register is | | | | | instruction | |
| an additional | | | | | register ( = | |
| offset bit | | | | | additional | |
| | | | | | offset bit) | |
| Bit 13 of the | 0 | 1 | 0 | DPP1.9-0 | DPP1.10 | 8 kbytes |
| instruction | | | | | | |
| register is a | | | | | | |
| selection bit | | | | | | |
| Bit 13 of the | 0 | 1 | 1 | EDPP1.9-0 | EDPP1.10 | 8 kbytes |
| instruction | | | | | | |
| register is a | | | | | | |
| selection bit | | | | | | |

where
DPP1.9-0: Bits 9-0 in the data memory segment register DPP1
DPP1.10: Bit 10 in the data memory segment register DPP1
EDPP1.9-0: Bits 9-0 in the additional data memory segment register EDPP1
EDPP1.10: Bit 10 in the additional data memory segment register EDPP1

TABLE 5
Switching mechanism for determining the most
significant address bits for selection of the mapping
rule which is stored in DPP2SEL.
(Addressing apparatus according to the invention)

| | | | | Output signals: | | Expla- |
|---|---|---|---|---|---|---|
| | Input signals | | | Most significant | | nation |
| Input signals: | Bits 15-13 of | | | address bits | | Memory |
| Memory | the instruc- | | | Bits 23-14 | | size of |
| configura- | tion register | | | of the | Bit 13 of | the data |
| tion register | Bit | Bit | Bit | address | the address | memory |
| field DPP2SEL | 15 | 14 | 13 | register | register | segment |
| Bit 13 of the | 1 | 0 | * | DPP2.9-0 | Bit 13 of | 16 kbytes |
| instruction | | | | | the | |
| register is | | | | | instruction | |
| an additional | | | | | register ( = | |
| offset bit | | | | | additional | |
| | | | | | offset bit) | |
| Bit 13 of the | 1 | 0 | 0 | DPP2.9-0 | DPP2.10 | 8 kbytes |
| instruction | | | | | | |
| register is a | | | | | | |
| selection bit | | | | | | |
| Bit 13 of the | 1 | 0 | 1 | EDPP2.9-0 | EDPP2.10 | 8 kbytes |
| instruction | | | | | | |
| register is a | | | | | | |
| selection bit | | | | | | |

where
DPP2.9-0: Bits 9-0 in the data memory segment register DPP2
DPP2.10: Bit 10 in the data memory segment register DPP2
EDPP2.9-0: Bits 9-0 in the additional data memory segment register EDPP2
EDPP2.10: Bit 10 in the additional data memory segment register EDPP2

TABLE 6
Switching mechanism for determining the most
significant address bits for selection of the mapping
rule which is stored in DPP3SEL.
(Addressing apparatus according to the invention)

| | | | | Output signals: | | Expla- |
|---|---|---|---|---|---|---|
| | Input signals | | | Most significant | | nation |
| Input signals: | Bits 15-13 of | | | address bits | | Memory |
| Memory | the instruc- | | | Bits 23-14 | | size of |
| configura- | tion register | | | of the | Bit 13 of | the data |
| tion register | Bit | Bit | Bit | address | the address | memory |
| field DPP3SEL | 15 | 14 | 13 | register | register | segment |
| Bit 13 of the | 0 | 0 | * | DPP3.9-0 | Bit 13 of | 16 kbytes |
| instruction | | | | | the | |
| register is | | | | | instruction | |
| an additional | | | | | register ( = | |
| offset bit | | | | | additional | |
| | | | | | offset bit) | |
| Bit 13 of the | 0 | 0 | 0 | DPP3.9-0 | DPP3.10 | 8 kbytes |
| instruction | | | | | | |
| register is a | | | | | | |
| selection bit | | | | | | |
| Bit 13 of the | 0 | 0 | 1 | EDPP3.9-0 | EDPP3.10 | 8 kbytes |
| instruction | | | | | | |
| register is a | | | | | | |
| selection bit | | | | | | |

where
DPP3.9-0: Bits 9-0 in the data memory segment register DPP3
DPP3.10: Bit 10 in the data memory segment register DPP3
EDPP3.9-0: Bits 9-0 in the additional data memory segment register EDPP3
EDPP3.10: Bit 10 in the additional data memory segment register EDPP3

The implementation illustrated in Tables 3, 4, 5 and 6 ensures compatibility with an existing program code which has been written for an addressing apparatus according to the prior art, as is illustrated by way of example in FIG. 1.

The memory configuration register 11 makes it possible to increase the number of data memory segments within the data memory 21 in accordance with a desired memory configuration, while at the same time ensuring that already existing programs can still run. Increasing the number of data memory segments makes it possible to write new programs which access a large number of data memory segments at the same time, without making the memory requirements for the program more stringent.

1. Apparatus for addressing a data memory (21), with the apparatus (1) having:
(a) an instruction register (2) for buffer-storing a program instruction, which
comprises an instruction opcode (2a), a memory configuration selection pointer (2b) for selection of a memory configuration register field, configuration bits (2c) and offset address bits (2d);
(b) a memory configuration register (11) which comprises a number of memory configuration register fields (11-i) which store different mapping instructions for generation of a data memory address in the data memory (21);
(c) a number of data memory segment registers (14) which each store the most significant address bits of a start address for a data memory segment, at least one additional data memory segment register (16) which stores the most significant address bits of a start address for a data memory segment,
(d) a switching mechanism (9) which reads the mapping instruction from the selected memory configuration register field (11-i) as a function of the memory configuration selection pointer (2b) read from the instruction register (2), and, depending on the mapping instruction that is read, interprets each individual bit of the configuration bits (2c) either as a selection bit or as an additional offset address bit, and composes the most significant address bits from the data memory segment register (14)/additional data memory segment register (16) selected by the selection bits and from the additional offset address bits, and writes the result to the most significant bit positions in an address register (19) which buffer-stores a data memory address for addressing the data memory (21),
with the least significant address bits of the address register (19) being taken from the offset address bits (2d) which are buffer-stored in the instruction register (2).

2. Apparatus according to claim 1, characterized in that
the memory configuration register field (11-i) contains a mapping rule which, for each individual bit of the configuration bits (2c), defines whether this bit should be interpreted as an additional offset address bit or as a selection bit for selection of a data memory segment register (14) and/or of an additional data memory segment register (16), and which also indicates which data memory segment registers (14) and additional data memory segment registers (16) are still available for selection.

3. Apparatus according to one of the preceding claims,
characterized in that the switching mechanism (9) composes the most significant address bits from the additional offset address bits which are selected by the mapping rule (which is read from the memory configuration register field (11-i)) from the configuration bits (2c) which are read from the instruction register (2), and from the selected data memory segment register (14)/additional data memory segment register (16).

4. Apparatus according to one of the preceding claims,
characterized in that the additional offset address bits are written by the switching mechanism to the most significant address bits in the address register (19).

5. Apparatus according to one of the preceding claims,
characterized in that the number of bits which are read from the addressed data memory segment register/additional data memory segment register and which the switching mechanism writes to the most significant address bits in the address register is obtained by means of the calculation rule (h-o), where h is the number of most significant address bits in the address register and o is the number of additional offset address bits.

6. Apparatus according to one of the preceding claims,
characterized in that offset address bits (2d), configuration bits (2c), selection bits (2b) and opcode bits (2a) are buffer-stored in the instruction register.

7. Apparatus according to one of the preceding claims,
characterized in that the address register (19) comprises a number of address bits, with the offset address bits (2d) which are stored in the instruction register (2) being copied as the least significant address bits directly to the address register (19), and
with the most significant address bits being written by the switching mechanism (9) (as a function of the data content of the memory configuration register field (11-i) selected by the selection bits (2b) which are stored in the instruction register) from a data memory segment register (14)/additional data memory segment register (16) and from the configuration bits (2c) which are stored in the instruction register (2).

8. Apparatus according to one of the preceding claims,
characterized in that the number of the most significant address bits (19a) and the number of the least significant address bits (19b) are constant.
List of reference symbols

| | |
|---|---|
| 1 | Addressing apparatus |
| 2 | Instruction register |
| 3 | Lines |
| 4 | Program memory |
| 5 | Lines |
| 6 | Central controller |
| 7 | Control lines |
| 8 | Lines |
| 9 | Switching mechanism |
| 10 | Lines |
| 11 | Memory configuration register |
| 12 | Lines |
| 13 | Lines |
| 14 | Data memory segment register |
| 15 | Lines |
| 16 | Additional data memory segment register |
| 17 | Lines |
| 18 | Lines |
| 19 | Address register |
| 20 | Address lines |
| 21 | Data memory |
